(19) United States
(12) Patent Application Publication
(10) Pub. No.: US 2021/0202984 A1
(43) Pub. Date: Jul. 1, 2021

(54) LITHIUM-ION SECONDARY BATTERY ELECTRODE AND LITHIUM-ION SECONDARY BATTERY

(71) Applicant: HONDA MOTOR CO., LTD., Tokyo (JP)

(72) Inventors: Takeshi FUJINO, Saitama (JP); Kazuki SAIMEN, Saitama (JP); Atsushi SAKURAI, Saitama (JP)

(21) Appl. No.: 17/058,661

(22) PCT Filed: May 15, 2019
(86) PCT No.: PCT/JP2019/019309

§ 371 Date: Nov. 25, 2020

(30) Foreign Application Priority Data
May 25, 2018 (JP) 2018-100590

(51) Int. Cl. H01M 10/0562; H01M 10/0525; H01M 4/62; C01G 23/00; C01G 25/00

(52) U.S. Cl. CPC H01M 10/0562; H01M 10/0525; H01M 4/62; H01M 2004/027; C01G 25/00; H01M 2300/0071; C01G 23/003

(57) ABSTRACT

Provided are lithium ions for achieving a lithium-ion secondary battery which is less susceptible to rises in internal resistance even over repeated charge-discharge cycles and which has excellent durability with respect to charge-discharge cycles.

A lithium-ion secondary battery 1 is provided with: a positive electrode; a negative electrode 7; a separator 8; an electrolyte solution 9; and a container 10 that houses the positive electrode 4, the negative electrode 7, the separator 8, and the electrolyte solution 9. At least one of the positive electrode mixture layer 3 or the negative electrode mixture layer 6 contains high-dielectric oxide solids 13, and the positive electrode active material 11 or the negative electrode active material 12 has a surface with portions thereof in contact with the high-dielectric oxide solids 13 and portions thereof in contact with the electrolyte solution 9.

This application is based on and claims the benefit of priority from Japanese Patent Application No. 2018-100590, filed on 25 May 2018, the content of which is incorporated herein by reference.

### TECHNICAL FIELD

The present invention relates to an electrode for a lithium ion secondary battery and a lithium ion secondary battery.

### BACKGROUND ART

Conventionally, various lithium ion secondary batteries using a lithium ion conductive solid electrolyte have been proposed. For example, lithium ion secondary batteries in which the positive electrode or negative electrode includes an active material coated with a coating layer containing an electroconductive auxiliary agent and a lithium ion conductive solid electrolyte are known (for example, see Patent Document 1).

It is disclosed that, according to the lithium ion secondary battery disclosed in Patent Document 1, since the active material in the positive electrode or the negative electrode is coated with the coating layer containing an electroconductive auxiliary agent and a lithium ion conductive solid electrolyte, internal resistance can be reduced, and deformation of the active material during charge and discharge can be suppressed, to prevent deterioration in the charge-discharge cycle characteristics and the high-rate discharge characteristics.
Patent Document 1: Japanese Unexamined Patent Application, Publication No. 2003-59492

### DISCLOSURE OF THE INVENTION

### Problems to be Solved by the Invention

However, although the lithium ion secondary battery disclosed in Patent Document 1 can satisfactorily obtain the above-mentioned effects at the initial stage of the charge-discharge cycle, there is a disadvantage that the durability against charge and discharge cycle rapidly decreases during use.

An object of the present invention is to provide an electrode for a lithium ion secondary battery which achieves a lithium ion secondary battery which eliminates this disadvantage, suppresses an increase in internal resistance even during repeated charge-discharge cycles, and has excellent durability against the charge-discharge cycle, and to provide the lithium ion secondary battery.

### Means for Solving the Problems

The present inventors have studied the reason why the durability against the charge and discharge cycle rapidly decreases during use of the lithium ion secondary battery disclosed in Patent Document 1.

As a result, the following has been found: In a high-density electrode in which the active material is densely packed in the electrode, it is difficult for the electrolyte solution to permeate into the electrode, which tends to make the impregnation of the electrolyte solution with respect to the active material in the electrode non-uniform. On the surface of the active material with less impregnation of the electrolyte solution, the release and injection of lithium ions is difficult to occur, so that the internal resistance is large, and when charge and discharge are repeated in this state, variation in the potential becomes large in the electrode, and the decomposition of the solvent occurs on the surface of the active material, and the electrolyte solution is depleted.

The present inventors have further studied based on the above findings, and found the following: As in the lithium ion secondary battery disclosed in Patent Document 1, for the active material coated with a coating layer containing an electroconductive auxiliary agent and a lithium ion conductive solid electrolyte, when the electrolyte solution is depleted, release and injection of lithium ions are less likely to occur on the surface of the active material, and the electrolyte solution is consumed. Thus, oxidation decomposition of the active material itself occurs in the positive electrode, and reduction decomposition of the active material itself occurs in the negative electrode, and the durability against the charge-discharge cycle decreases.

The depletion of the electrolyte solution and the resulting oxidation decomposition or reduction decomposition of the active material are further accelerated by the fact that, when the charge and discharge cycles are repeated, the electrolyte solution is pushed out by the expansion of the electrode due to the battery reaction, the electrolyte solution decreases in the central part of the electrode, and the presence of the electrolyte solution in the electrode becomes non-uniform.

Therefore, based on the above findings, an electrode for a lithium ion secondary battery of the present invention includes an electrode mixture layer containing an electrode active material and high dielectric oxide solids. The electrode active material includes sites in contact with the high dielectric oxide solids and sites in contact with an electrolyte solution on the active material surface.

Since the electrode for a lithium ion secondary battery of the present invention includes the sites in contact with high dielectric oxide solids and the sites in contact with an electrolyte solution on the surface of the electrode active material, the electrolyte solution can reduce the surface potential of the electrode active material, and can reduce the interface resistance of lithium ions between the electrode active material and the high dielectric oxide solids. Therefore, the transfer resistance of lithium ions between the electrode active material and the high dielectric oxide solids can be reduced, and an increase in internal resistance can be suppressed even when the charge-discharge cycles are repeated.

In addition, in the electrode for a lithium ion secondary battery of the present invention, the electrode active material includes sites in contact with an electrolyte solution on the active material surface, and can sufficiently contact with the electrolyte solution at the sites.

Therefore, even on the surface of the active material which has conventionally been reduced in impregnation of the electrolyte solution, decomposition of a solvent can be greatly suppressed, and consumption of the electrolyte solution can be suppressed.

Therefore, according to the electrode for a lithium ion secondary battery of the present invention, since the electrolyte solution is not depleted in the electrode, the contact between the surface of the active material and the electrolyte solution in the electrode is successfully maintained, the potential in the electrode becomes uniform, and it is possible to suppress a partially high or low potential.

As a result, according to the electrode for a lithium ion secondary battery of the present invention, it is possible to greatly suppress the oxidation decomposition reaction of the active material itself in the positive electrode or the reduction decomposition reaction of the active material itself in the negative electrode, and to obtain excellent durability against the charge-discharge cycle.

In the electrode for a lithium ion secondary battery of the present invention, the high dielectric oxide solids may be disposed in a gap between the electrode active materials.

In the electrode for a lithium ion secondary battery of the present invention, since the high dielectric oxide solids are disposed in a gap between the electrode active materials, the internal resistance can be further reduced.

In the electrode for a lithium ion secondary battery of the present invention, the high dielectric oxide solids may be an oxide solid electrolyte.

In the electrode for a lithium ion secondary battery of the present invention, if the high dielectric oxide solids are an oxide solid electrolyte, the output of the obtained lithium ion secondary battery at low temperatures can be further improved.

Furthermore, an electrode for a lithium ion secondary battery excellent in electrochemical oxidation and reduction resistance can be prepared at relatively low cost, and further, since the oxide solid electrolyte has a small true specific gravity, an increase in cell weight can be suppressed.

The electrode for a lithium ion secondary battery of the present invention may be a positive electrode.

When the electrode for a lithium ion secondary battery of the present invention is a positive electrode, it is possible to improve the output of the resultant lithium ion secondary battery and the durability against the charge-discharge cycle.

When the electrode for a lithium ion secondary battery of the present invention is a positive electrode, the high dielectric oxide solids may be an oxidation decomposition resistant lithium ion conductive solid electrolyte.

When the electrode for a lithium ion secondary battery of the present invention is a positive electrode, if the high dielectric oxide solids are an oxidation decomposition resistant lithium ion conductive solid electrolyte, oxidation decomposition of the high dielectric oxide solids can be suppressed in the positive electrode, and further excellent durability against the charge-discharge cycle can be obtained.

When the electrode for a lithium ion secondary battery of the present invention is a positive electrode, the oxidation decomposition resistant lithium ion conductive solid electrolyte may have an oxidation decomposition potential of 4.5 V (4.5 V vs Li/Li⁺) or more versus Li/Li⁺ equilibrium potential.

When the electrode for a lithium ion secondary battery of the present invention is a positive electrode, if the oxidation decomposition potential of the oxidation decomposition resistant lithium ion conductive solid electrolyte is 4.5 V or more versus Li/Li⁺ equilibrium potential, it is possible to suppress the oxidation decomposition and elution of the constituent metal element during charge, and thus it is possible to suppress a decrease in the lithium ion conductivity due to the structural change.

When the electrode for a lithium ion secondary battery of the present invention is a positive electrode, the oxidation decomposition resistant lithium ion conductive solid electrolyte may be at least one of Li_{1.6}Al_{0.6}Ti_{1.4}(PO₄)₃ or Li_{1+x+y}(Al,Ga)ₓ(Ti,Ge)₂₋ₓSi_{y}P_{3-y}O₁₂ (0≤x≤1, 0≤y≤1).

The electrode for a lithium ion secondary battery may be a negative electrode.

When the electrode for a lithium ion secondary battery of the present invention is a negative electrode, the amount of charge of the resultant lithium ion secondary battery at low temperatures can be increased and the quick charge capability and durability can be improved.

When the electrode for a lithium ion secondary battery of the present invention is a negative electrode, the high dielectric oxide solids may be a reduction decomposition resistant lithium ion conductive solid electrolyte.

When the electrode for a lithium ion secondary battery of the present invention is a negative electrode, if the high dielectric oxide solids are a reduction decomposition resistant lithium ion conductive solid electrolyte, reduction decomposition of the high dielectric oxide solids can be suppressed in the negative electrode, and further excellent durability against the charge-discharge cycle can be obtained.

When the electrode for a lithium ion secondary battery is a negative electrode, the reduction decomposition resistant lithium ion conductive solid electrolyte may have a reduction decomposition potential of 1.5 V (1.5 V vs Li/Li⁺) or less versus Li/Li⁺ equilibrium potential.

When the electrode for a lithium ion secondary battery of the present invention is a negative electrode, if the reduction decomposition potential of the reduction decomposition resistant lithium ion conductive solid electrolyte is 1 5 V or less versus Li/Li⁺ equilibrium potential, it is possible to suppress the reduction decomposition and elution of the constituent metal element during charge, and thus it is possible to suppress a decrease in the lithium ion conductivity due to the structural change.

When the electrode for a lithium ion secondary battery of the present invention is a negative electrode, the reduction decomposition resistant lithium ion conductive solid electrolyte may be at least one of Li₇La₃Zr₂O₁₂ or Li_{2.88}PO_{3.73}N_{0.14}.

Another aspect of the present invention relates to a lithium ion secondary battery including a positive electrode, a negative electrode, a separator that electrically insulates the positive electrode and the negative electrode, and an electrolyte solution, in which the positive electrode is the electrode for a lithium ion secondary battery described above.

Still another aspect of the present invention relates to a lithium ion secondary battery including a positive electrode, a negative electrode, a separator that electrically insulates the positive electrode and the negative electrode, and an electrolyte solution, in which the negative electrode is the electrode for a lithium ion secondary battery described above.

In the lithium ion secondary battery of the present invention, if at least one of the positive electrode or the negative electrode is the electrode for a lithium ion secondary battery of the present invention, even when the charge-discharge cycle is repeated, an increase in internal resistance can be suppressed, and a lithium ion secondary battery having excellent durability against the charge-discharge cycle can be achieved.

Still another aspect of the present invention relates to a lithium ion secondary battery including a positive electrode, a negative electrode, a separator that electrically insulates the positive electrode and the negative electrode, and an electrolyte solution, in which the positive electrode is the electrode for a lithium ion secondary battery described above, and the negative electrode is the electrode for a lithium ion secondary battery described above.

In the lithium ion secondary battery of the present invention, when both the positive electrode and the negative electrode are the electrodes for a lithium ion secondary battery of the present invention, an increase in internal resistance when the charge-discharge cycle is repeated can be further suppressed, which results in a lithium ion secondary battery having more excellent durability against the charge-discharge cycle.

The lithium ion secondary battery of the present invention includes a container that houses the positive electrode, the negative electrode, the separator, and the electrolyte solution. The separator may be in contact with the electrolyte solution stored in the container.

Since the lithium ion secondary battery of the present invention includes the container for such housing, and the separator is in contact with the electrolyte solution stored in the container, when the electrolyte solution is consumed, the positive electrode and the negative electrode can be replenished with an electrolyte solution via the separator.

### BRIEF DESCRIPTION OF THE DRAWINGS

FIG. 1 is an explanatory cross-sectional view showing a configuration example of a lithium ion secondary battery of the present invention;

FIG. 2 is a schematic view showing the surface of a positive electrode active material or a negative electrode active material used in an electrode for a lithium ion secondary battery of the present invention;

FIG. 3 is a graph showing the initial internal resistance of lithium ion secondary batteries of the present invention; and

FIG. 4 is a graph showing the discharge capacity maintenance rates with respect to the charge-discharge cycles of the lithium ion secondary batteries of the present invention.

### PREFERRED MODE FOR CARRYING OUT THE INVENTION

An embodiment of the present invention will now be described in more detail with reference to the accompanying drawings.

### First Embodiment

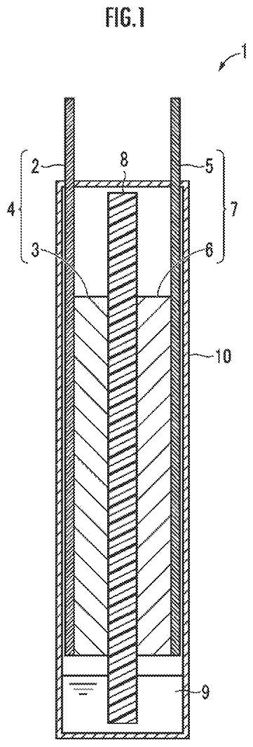

As shown in FIG. 1, a lithium ion secondary battery 1 of the present embodiment includes a positive electrode 4 including a positive electrode mixture layer 3 formed on a positive electrode current collector 2, a negative electrode 7 including a negative electrode mixture layer 6 formed on a negative electrode current collector 5, a separator 8 that electrically insulates the positive electrode 4 and the negative electrode 7, an electrolyte solution 9, and a container 10 that houses the positive electrode 4, the negative electrode 7, the separator 8, and the electrolyte solution 9.

In the container 10, the positive electrode mixture layer 3 and the negative electrode mixture layer 6 are opposed to each other with the separator 8 interposed therebetween, and the electrolyte solution 9 is stored below the positive electrode mixture layer 3 and the negative electrode mixture layer 6.

An end of the separator 8 is immersed in the electrolyte solution 9.

The positive electrode mixture layer 3 contains a positive electrode active material 11, and the negative electrode mixture layer 6 contains a negative electrode active material 12.

Furthermore, at least one of the positive electrode mixture layer 3 or the negative electrode mixture layer 6 contains high dielectric oxide solids 13.

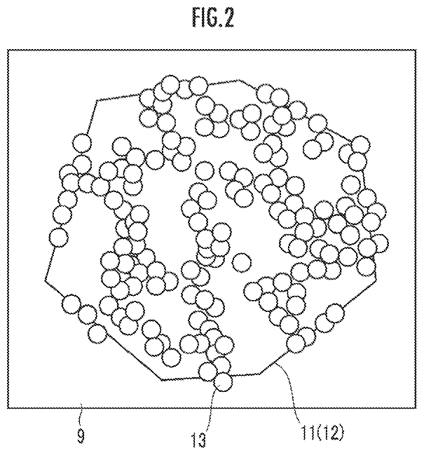

In the case where the positive electrode mixture layer 3 or the negative electrode mixture layer 6 contains the high dielectric oxide solids 13, as shown in FIG. 2, the positive electrode active material 11 or the negative electrode active material 12 includes sites in contact with the high dielectric oxide solids 13 and sites in contact with the electrolyte solution 9 on the active material surface. In other words, the positive electrode active material 11 or the negative electrode active material 12 is in contact with the high dielectric oxide solids 13 on parts of the active material surface and in contact with the electrolyte solution 9 on the rest of the surface.

In the positive electrode 4 or the negative electrode 7 of the lithium ion secondary battery 1 of this embodiment, since the positive electrode active material 11 or the negative electrode active material 12 includes sites in contact with the high dielectric oxide solids 13 and sites in contact with the electrolyte solution 9 on the active material surface, the electrolyte solution 9 enables the surface potential of the positive electrode active material 11 or the negative electrode active material 12 to be reduced, and the interface resistance of lithium ions between the positive electrode active material 11 or the negative electrode active material 12 and the high dielectric oxide solids 13 can be reduced.

As a result, the transfer resistance of lithium ions between the positive electrode active material 11 or the negative electrode active material 12 and the high dielectric oxide solids 13 can be reduced, and an increase in internal resistance can be suppressed even when the charge-discharge cycle is repeated.

In addition, in the positive electrode 4 or the negative electrode 7 of the lithium ion secondary battery 1 of the embodiment, since the positive electrode active material 11 or the negative electrode active material 12 includes sites in contact with the electrolyte solution 9 on the active material surface, the active material can sufficiently contact with the electrolyte solution at the sites.

Thus, even at the surface of the active material, which has conventionally been less impregnated with the electrolyte solution, the decomposition of the solvent can be significantly suppressed, and the consumption of the electrolyte solution can be suppressed.

Therefore, in the positive electrode 4 or the negative electrode 7 of the lithium ion secondary battery 1 of the embodiment, the electrolyte solution 9 is not depleted, so that the contact between the surface of the positive electrode active material 11 or the negative electrode active material 12 and the electrolyte solution 9 in the electrode is well maintained, the potential in the electrode becomes uniform, and thus it is possible to suppress a partially high or low potential.

As a result, the positive electrode 4 or the negative electrode 7 of the lithium ion secondary battery 1 of the embodiment can greatly suppress the oxidation decomposition reaction of the active material itself in the positive electrode or the reduction decomposition reaction of the active material itself in the negative electrode, and thus, excellent durability against the charge-discharge cycle can be obtained.

In particular, when the positive electrode mixture layer 3 contains the high dielectric oxide solids 13 in the lithium ion secondary battery 1, the excellent effect of improving the output and the durability against the charge-discharge cycle in the positive electrode can be obtained.

When the positive electrode mixture layer 3 contains the high dielectric oxide solids 13, the positive electrode mixture layer 3 preferably contains the high dielectric oxide solids 13 in the range of 0.1 to 5% by mass with respect to the total amount thereof, and the high dielectric oxide solids 13 preferably cover 1 to 80% of the surface of the positive electrode active material 11.

If the high dielectric oxide solids 13 cover more than 80's of the surface of the positive electrode active material 11, the resistance when lithium ions reach the positive electrode active material 11 becomes excessively large, and the durability is lowered.

On the other hand, if the high dielectric oxide solids 13 cover less than 1 of the surface of the positive electrode active material 11, the above effect due to the high dielectric oxide solids 13 cannot be obtained.

In addition, in the lithium ion secondary battery 1, when the negative electrode mixture layer 6 contains the high dielectric oxide solids 13, the effect of increasing the amount of charge at low temperatures and improving the quick charge capability and durability can be obtained.

When the negative electrode mixture layer 6 contains the high dielectric oxide solids 13, the negative electrode mixture layer 6 preferably contains the high dielectric oxide solids 13 in the range of 0.1 to 5% by mass with respect to the total amount thereof, and the high dielectric oxide solids 13 preferably cover 1 to 80% of the surface of the negative electrode active material 12.

If the high dielectric oxide solids 13 cover more than 80% of the surface of the negative electrode active material 12, the resistance when lithium ions reach the negative electrode active material 12 becomes excessively large, and the durability is lowered.

On the other hand, if the high dielectric oxide solids 13 cover less than 1% of the surface of the negative electrode active material 12, the above effect due to the high dielectric oxide solids 13 cannot be obtained.

Although not shown, when the mass ratio of the high dielectric oxide solids 13 in the positive electrode mixture layer 3 or the negative electrode mixture layer 6 is increased, the high dielectric oxide solids 13 are disposed in gaps between the positive electrode active materials 11 or gaps between the negative electrode active materials 12 in addition to the surface of the positive electrode active material 11 or the negative electrode active material 12. Since the high dielectric oxide solids 13 are disposed in gaps between the positive electrode active materials 11 or gaps between the negative electrode active materials 12, the internal resistance of the resultant lithium ion secondary battery can be further reduced.

When the high dielectric oxide solids 13 are disposed in the gap between the positive electrode active materials 11 or the negative electrode active materials 12, it is preferable that the ratio of the cross-sectional area of the high dielectric oxide solids 13 to that of the electrolyte solution 9 part, which are present in the gap, is in the range of 2 to 20:98 to 80 in the cross-sectional observation of the electrode mixture layer.

By setting the ratio in the above range, the transfer of lithium ions in the electrolyte solution 9 existing in the gap is accelerated by the high dielectric oxide solids 13 and is not hindered by the presence of the high dielectric oxide solids 13.

Therefore, it is possible to reduce the internal resistance of the lithium ion secondary battery 1 at the time of continuous discharge or continuous charge in driving an electric vehicle or the like by increasing the mass ratio of the high dielectric oxide solids 13 in the positive electrode mixture layer 3 or the negative electrode mixture layer 6.

[Current Collector]

In the lithium ion secondary battery 1, the material of the positive electrode current collector 2 and the negative electrode current collector 5 may be copper, aluminum, nickel, titanium, a foil or plate made of stainless steel, a carbon sheet, a carbon nanotube sheet, or the like.
The positive electrode current collector 2 and the negative electrode current collector 5 can be mainly composed of a single material of any one of the above materials, but can also be composed of a metal clad foil or the like composed of two or more materials as necessary.
The positive electrode current collector 2 and the negative electrode current collector 5 may have a thickness in the range of 5 to 100 μm, and preferably have a thickness in the range of 7 to 20 μm in terms of structure and performance.

[Electrode Mixture Layer]

The positive electrode mixture layer 3 includes a positive electrode active material 11, an electroconductive auxiliary agent, and a binder. The negative electrode mixture layer 6 includes a negative electrode active material 12, an electroconductive auxiliary agent, and a binder.

(Positive Electrode Active Material)

Examples of the positive electrode active material 11 include lithium complex oxides (LiNiₓCo_{y}Mn_{z}O₂ (x+y+z=1), LiNiₓCo_{y}Al_{z}O₂ (x+y+z=1)), and lithium iron phosphate (LiFePO₄ (LFP)), and one or more of them can be used.

(Negative Electrode Active Material)

Examples of the negative electrode active material 12 include carbon powder (amorphous carbon), silica (SiO_{z}), titanium complex oxides (Li₄Ti₅O₇, TiO₂, Nb₂TiO₇), tin complex oxides, lithium alloys, and metallic lithium, and one or more of them can be used.
As the carbon powder, one or more of soft carbon (easily graphitized carbon), hard carbon (hardly graphitized carbon), and graphite can be used.

(Electroconductive Auxiliary Agent)

Examples of the electroconductive auxiliary agent include carbon black such as acetylene black (AB) and Ketjen black (KB), carbon material such as graphite powder, and electroconductive metal powder such as nickel powder, and one or more of them can be used.

(Binder)

Examples of the binder include a cellulose-based polymer, a fluorine-based resin, a vinyl acetate copolymer, and a rubber, and one or more of them can be used.
Specifically, as a binder when a solvent-based dispersion medium is used, polyvinylidene fluoride (PVDF), polyimide (PI), polyvinylidene chloride (PVdC), polyethylene oxide (PEO), or the like can be used. As a binder when an aqueous dispersion medium is used, styrene butadiene rubber (SBR), acrylic acid-modified SBR resin (SBR-based latex), carboxymethyl cellulose (CMC), polyvinyl alcohol (PVA), polytetrafluoroethylene (PTFE), hydroxypropylmethylcellulose (HPMC), fluorinated ethylene propylene copolymer (FEP), or the like can be used.

[Separator]

Examples of the separator 6 include porous resin sheets (films, nonwoven fabrics, and the like) made of a resin such as polyethylene (PE), polypropylene (PP), polyester, cellulose, or polyamide.

[Electrolyte Solution]

The electrolyte solution 9 may be composed of a nonaqueous solvent and an electrolyte, and the concentration of the electrolyte is preferably in the range of 0.1 to 10 mol/L.

(Nonaqueous Solvent)

Examples of the nonaqueous solvent include aprotic solvents such as carbonates, esters, ethers, nitriles, sulfones, and lactones. Specifically, ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THF), 2-methyltetrahydrofuran, dioxane, 1,3-dioxolane, diethylene glycol dimethyl ether, ethylene glycol dimethyl ether, acetonitrile (AN), propionitrile, nitromethane, N,N-dimethylformamide (DMF), dimethyl sulfoxide, sulfolane, γ-butyrolactone, and the like may be used.

(Electrolyte)

Examples of the electrolyte include LiPF₆, LiBF₄, LiClO₄, LiN(SO₂CF₃), LiN(SO₂C₂F₅)₂, LiCF₃SO₃, LiC₄F₉SO₃, LiC(SO₂CF₃)₃, LiF, LiCl, LiI, Li₂S, Li₃N, Li₃P, Li₁₀GeP₂S₁₂ (LGPS), Li₃PS₄, Li₆PS₅Cl, Li₇P₂S₈I, LiₓPO_{y}N_{z} (x=2y+3z−5, LiPON), Li₇La₃Zr₂O₁₂ (LLZO), Li₃ₓLa_{2/3-x}TiO₃ (LLTO), Li₁₊ₓAlₓTi₂₋ₓ(PO₄)₃ (0≤x≤1, LATP), Li_{1.5}Al_{0.5}Ge_{1.5}(PO₄)₃ (LAGP), Li_{1+x+y}AlₓTi₂₋ₓSiyP_{3-y}O₁₂, Li_{1+x+y}Al_{y} (Ti,Ge)₂₋ₓSiyP_{3-y}O₁₂, and Li₄₋₂ₓZnₓGeO₄ (LISICON), but LiPF₆, LiBF₄ or a mixture thereof is preferable.

Examples of the electrolyte solution 9 include an ionic liquid or an ionic liquid including a polymer containing an aliphatic chain such as polyethylene oxide (PEW) or a polyvinylidene fluoride (PVDF) copolymer.

The electrolyte solution 9 including an ionic liquid can flexibly cover the surface of the positive electrode active material 11 or the negative electrode active material 12, and a site of contact between the surface of the positive electrode active material 11 or the negative electrode active material 12 and the electrolyte solution 9 can be formed.

The electrolyte solution 9 fills the gaps in the positive electrode mixture layer 3 and the negative electrode mixture layer 6 and the pores in the separator 8, while being stored in the bottom of the container 10.

The mass of the electrolyte solution 9 filling the gaps in the positive electrode mixture layer 3 and the negative electrode mixture layer 6 and the pores in the separator 8 can be calculated from the total volume of the gaps in the positive electrode mixture layer 3 and the negative electrode mixture layer 6 and the pores in the separator 8, which is measured with a mercury porosimeter, and the specific gravity of the electrolyte solution 9.
Alternatively, it can be calculated in the following manner: The volume of the gaps in each mixture layer is calculated from the density of the positive electrode mixture layer 3 and the negative electrode mixture layer 6 and the density of the material constituting each mixture layer, and the volume of the pores in the separator 8 is calculated from the porosity of the separator 8 to obtain the total volume of the gaps in the positive electrode mixture layer 3 and the negative electrode mixture layer 6 and the pores in the separator 8. Thus, the mass of the electrolyte solution 9 is calculated from the obtained total volume and the specific gravity of the electrolyte solution 9.

The mass of the electrolyte solution 9 stored in the bottom of the container 10 may be in the range of 3 to 25% by mass of the mass of the electrolyte solution 9 filling the gaps in the positive electrode mixture layer 3 and the negative electrode mixture layer 6 and the pores in the separator 8.

Since the separator 8 of the lithium ion secondary battery of the embodiment is in contact with the electrolyte solution 9 stored in the container 10, the electrolyte solution 9 can replenish the positive electrode mixture layer 3 and the negative electrode mixture layer 6 via the separator 8 when the electrolyte solution 9 is consumed.

[High Dielectric Oxide Solid]

The high dielectric oxide solid 13 contained in at least one of the positive electrode mixture layer 3 or the negative electrode mixture layer 6 is a solid having a high dielectric constant.
Normally, the dielectric constant of the solid particles pulverized from the crystalline state changes from that of the original crystalline state, and the dielectric constant decreases.
Therefore, for the high dielectric oxide solid used in the present invention, it is preferable to use the pulverized powder in a state in which the high dielectric state can be maintained as much as possible.

The powder relative dielectric constant of the high dielectric oxide solid used in the present invention is preferably 10 or more, and more preferably 20 or more.

If the powder relative dielectric constant is 10 or more, an increase in internal resistance can be suppressed even when the charge-discharge cycle is repeated, and thus a lithium ion secondary battery having excellent durability against the charge-discharge cycle can be sufficiently achieved.

The “powder relative dielectric constant” in the present specification refers to a value obtained as follows:

### [Measuring Method of Powder Relative Dielectric Constant]

The powder is introduced into a tablet molding machine having a diameter (R) of 38 mm for measurement, and compressed using a hydraulic press machine so that the thickness (d) is 1 to 2 mm, to form a green compact.
For the forming condition of the green compact, the relative density (D_{powder}) of the powder=the weight density of the green compact/the true specific gravity of the dielectric×100 is 40% or more. For the compact, the capacitance Cₜₒₜₐₗ at 1 kHz at 25° C. is measured using an LCR meter by an automatic balancing bridge method, to calculate the relative dielectric constant ∈ₜₒₜₐₗ of the green compact.
To determine the dielectric constant ε_{power} of the actual volume from the obtained relative dielectric constant of the green compact, the “powder relative dielectric constant ε_{power}” is calculated by defining the dielectric constant ε₀ of vacuum as 8.854×10⁻¹² and the relative dielectric constant εₐᵢᵣ of air as 1, using the following equations (1) to (3).

The contact area A between the green compact and the electrode=(R/2)²*π (1)

Cₜₒₜₐₗ=εₜₒₜₐₗ×ε₀×(A/d) (2)

εₜₒₜₐₗ=ε_{power}×D_{powder}+εₐᵢᵣ×(1−D_{powder}) (3)

From the viewpoint of improving the electrode volume packing density of the active material, the particle diameter of the high dielectric oxide solid 13 is preferably ⅕ or less of the particle diameter of the positive electrode active material 11 or the negative electrode active material 12, and further preferably in the range of 0.02 to 1 μm.

When the particle diameter of the high dielectric oxide solid 13 is 0.02 μm or less, the high dielectric property cannot be maintained, and the effect of suppressing an increase in resistance cannot be obtained.

The high dielectric oxide solid 13 may or may not have lithium ion conductivity, but is preferably an oxide solid electrolyte having lithium ion conductivity.

A high dielectric oxide solid having lithium ion conductivity can further improve the output of the resultant lithium ion secondary battery at low temperatures.
Furthermore, an electrode for a lithium ion secondary battery excellent in electrochemical oxidation and reduction resistance can be prepared at relatively low cost. In addition, since the oxide solid electrolyte has a small true specific gravity, an increase in cell weight can be suppressed.

Examples of the high dielectric oxide solid 13 include complex metal oxides having a perovskite-type crystal structure such as BaTiO₃, BaₓSr₁₋ₓTiO₃ (X=0.4 to 0.8), BaZrₓTi₁₋ₓO₃ (X=0.2 to 0.5), and KNbO₃, and complex metal oxides having a layered perovskite-type crystal structure containing bismuth such as SrBi₂Ta₂O₃ and SrBi₂Nb₂O₉.

Other examples thereof include complex oxides having an ilmenite structure of LiₓNb_{y}O or LiₓTa_{y}O₃ (x/y=0.9 to 1.1), Li₃PO₄, LiₓPO_{y}N_{z} (x=2y+3z−5, LIPON), Li₇La₃Zr₂O₁₂ (LLZO), Li₃ₓLa_{2/3-x}TiO₂ (LLIO), Li₁₊ₓAlₓTi₂₋ₓ(PO₄)₃ (0≤x≤1, LATP), Li_{1.5}Al_{0.5}Ge_{1.5}(PO₄)₃ (LAGP), Li_{1+x+y}AlₓTi₂₋ₓP_{3-y}O₁₂, Li_{1+x+y}Alₓ (Ti,Ge)₂₋ₓSi_{y}P_{3-y}O₁₂, and Li₄₋₂ₓZnₓGeO₄ (LISICON).

As described above, in the lithium ion secondary battery 1, at least one of the positive electrode mixture layer 3 or the negative electrode mixture layer 6 may contain the high dielectric oxide solids 13.

In the lithium ion secondary battery 1, when the positive electrode mixture layer 3 of the positive electrode 4 contains the high dielectric oxide solids 13, the high dielectric oxide solids 13 are preferably an oxidation decomposition resistant lithium ion conductive solid electrolyte.

When the positive electrode mixture layer 3 of the positive electrode 4 contains an oxidation decomposition resistant lithium ion conductive solid electrolyte, oxidation decomposition of the high dielectric oxide solids can be suppressed in the positive electrode, and further excellent durability against the charge and discharge cycle can be obtained.

The oxidation decomposition resistant lithium ion conductive solid electrolyte preferably has an oxidation decomposition potential of 4.5 V (4.5 V vs Li/Li⁺) or more versus Li/Li⁺ equilibrium potential.

When the oxidation decomposition potential of the oxidation decomposition resistant lithium ion conductive solid electrolyte is less than 4.5 V versus Li/Li⁺ equilibrium potential, the constituent metal element is eluted by oxidation decomposition during charge, and the lithium ion conductivity is lowered due to the structural change. In addition, when the oxidation decomposition of the oxidation decomposition resistant lithium ion conductive solid electrolyte is performed, electric charge is consumed in the oxidation decomposition and the active material is not charged. Thus, the working potential range of the lithium ion secondary battery fluctuates and the capacity is lowered, and the durability is remarkably deteriorated during the charge-discharge cycle.

The oxidation decomposition resistant lithium ion conductive solid electrolyte is preferably oxide glass ceramics, and for example, preferably at least one of Li_{1.6}Al_{0.6}Ti_{1.4}(PO₄)₃), or Li_{1+x+y}(Al, Ga)ₓ(Ti, Ge)₂₋ₓSi_{y}P_{3-y}O₁₂ (0≤x≤1, 0≤y≤1).

Among these, LATP (Li_{1.6}Al_{0.6}Ti_{1.4}(PO₄)₃), LAGP (Li_{1.5}Al_{0.5}Ge_{1.5}(PO₄)₃), and Li_{1+x+y}Alₓ(Ti,Ge)₂₋ₓSi_{y}P_{3-y}O₁₂ (0≤x≤1, 0≤y≤1) are particularly preferred.

In the lithium ion secondary battery 1, when the negative electrode mixture layer 6 of the negative electrode 7 contains the high dielectric oxide solids 13, the high dielectric oxide solids 13 are preferably a reduction decomposition resistant lithium ion conductive solid electrolyte.

When the negative electrode mixture layer 6 of the negative electrode 7 contains a reduction decomposition resistant lithium ion conductive solid electrolyte, reduction decomposition of the high dielectric oxide solids can be suppressed in the negative electrode, and further excellent durability against the charge-discharge cycle can be obtained.

The reduction decomposition resistant lithium ion conductive solid electrolyte preferably has a reduction decomposition potential of 1.5 V (1.5 V vs Li/Li⁺) or less versus Li/Li⁺ equilibrium potential.

When the reduction decomposition potential of the reduction decomposition resistant lithium ion conductive solid electrolyte exceeds 1 5 V versus Li/Li⁺ equilibrium potential, the constituent metal element is eluted by reduction decomposition during charge, and the lithium ion conductivity is lowered due to the structural change. In addition, when the reduction decomposition of the reduction decomposition resistant lithium ion conductive solid electrolyte is performed, electric charge is consumed in the reduction decomposition and the active material is not charged. Thus, the working potential range of the lithium ion secondary battery fluctuates and the capacity is lowered, and the durability is remarkably deteriorated during the charge-discharge cycle.

The reduction decomposition resistant lithium ion conductive solid electrolyte is preferably at least one of LLZO (Li₇La₃Zr₂O₁₂) or LIPON (Li_{2.88}PO_{3.73}N_{0.14}).

Among them, LLZO is particularly preferred because the redox potential of Li is close to the redox potential of Li of a negative electrode active material such as graphite and hard carbon.

Examples and comparative examples of the present invention will be described.

### EXAMPLES

### Example 1

### [Preparation of Positive Electrode]

In this Example, 1 part by mass of Li_{1.6}Al_{0.6}Ti_{1.4}(PO₄)₃ (hereinafter abbreviated as LATP) as high dielectric oxide solids 13 was added to 100 parts by mass of LiNi_{0.6}Co_{0.2}Mn_{0.2}O₂ (hereinafter abbreviated as NCM622) as a positive electrode active material 11, and NCM622 to which LATP was added (hereinafter abbreviated as LATP added NCM622) was prepared.
NCM622 had a median diameter (D50) of 12.4 μm, and LATP had a median diameter of 0.4 μm.
The powder relative dielectric constant of LATP was 30.

Next, LATP added NCM622, acetylene black (AB) as an electroconductive auxiliary agent, and polyvinylidene fluoride (PVDF) as a binder at a mass ratio of LATP added NCM622:AB:PVDF=93:4:3 were mixed with N-methyl-N-pyrrolidinone (NMP) as a dispersing solvent, to prepare a positive electrode paste.

That is, the blending amount of the high dielectric oxide solids 13 in a positive electrode mixture layer 3 is 0.9% by mass.

Next, the positive electrode paste was applied to an aluminum positive electrode current collector 2, dried, and pressurized by a roll press, and then dried in a vacuum at 120° C., to form the positive electrode mixture layer 3.

The density of the positive electrode mixture layer 3 was 3.4 g/cm³, and the volume of the gaps in the positive electrode mixture layer 3 was 0.0195 cm³.

Next, the positive electrode current collector 2 on which the positive electrode mixture layer 3 was formed was punched to a size of 30 mm×40 mm to obtain a positive electrode 4.

[Preparation of Negative Electrode]

Next, artificial graphite (AG) as a negative electrode active material 12, acetylene black (AB) as an electroconductive auxiliary agent, and carboxy methylcellulose (CMC) and styrene butadiene rubber (SBR) as a binder at a mass ratio of AG:AB:CMC:SBR=96.5:1:1:1.5 were mixed with distilled water as a dispersing solvent, to prepare a negative electrode paste.
The artificial graphite had a median diameter of 12.0 μm.

Next, the negative electrode paste was applied to a copper negative electrode current collector 5, dried, and pressurized by a roll press, and then dried in a vacuum at 100° C., to form a negative electrode mixture layer 6.

The density of the negative electrode mixture layer 6 was 1.6 g/cm³, and the volume of the gaps in the negative electrode mixture layer 6 was 0.0335 cm³.

Next, the negative electrode current collector 5 on which the negative electrode mixture layer 6 was formed was punched to a size of 34 mm×44 mm to obtain a negative electrode 7.

[Preparation of Lithium Ion Secondary Battery]

Next, a separator 8 was sandwiched between the positive electrode mixture layer 3 of the positive electrode 4 and the negative electrode mixture layer 6 of the negative electrode 7 in a container 10 in which an aluminum laminate for secondary batteries (manufactured by Dainippon Printing Co., Ltd.) was heat-sealed and processed into a pouch shape, so that a part where the positive electrode mixture layer 3 of the positive electrode current collector 2 was not formed and a part where the negative electrode mixture layer 6 of the negative electrode current collector 5 was not formed were outside the container 10. After an electrolyte solution 9 was injected into the container 10, the container 10 was vacuum-sealed, thereby preparing a lithium ion secondary battery 1 in which an end of the separator 8 was immersed in the electrolyte solution 9 stored in the bottom, as shown in FIG. 1.

As the separator 8, a PP/PE/PP having a thickness of 20 μm and a volume of gaps of 0.036 cm³ was used.

Furthermore, as the electrolyte solution 9, a solution in which LiPF₆ as a support salt was dissolved at a concentration of 1.2 mol/L in a mixed solvent in which ethylene carbonate, diethyl carbonate, and ethyl methyl carbonate were mixed at a volume ratio of 20:40:40 was used.

For the electrolyte solution 9, 0.128 g corresponding to 120 parts by mass in total, which is 100 parts by mass of the mass filling the total volume of the gaps in the positive electrode mixture layer 3, the negative electrode mixture layer 6, and the separator 8, and 20 parts by mass of the mass stored in the container 10, was injected into the container 10.

The lithium ion secondary battery 1 in this Example includes the high dielectric oxide solids 13 only in the positive electrode 4. As shown in FIG. 2, the positive electrode active material 11 is in contact with the high dielectric oxide solids 13 on parts of the active material surface, and is in contact with the electrolyte solution 9 on the rest of the surface.

### Example 2

### [Preparation of Lithium Ion Secondary Battery]

A lithium ion secondary battery 1 was prepared in the same manner as in Example 1 except that 4 parts by mass of LATP was added to 100 parts by mass of NCM622 as a positive electrode active material 11. That is, the blending amount of high dielectric oxide solids 13 in the positive electrode mixture layer 3 was 3.6% by mass.

### Example 3

### Preparation of Negative Electrode

First, 3 parts by mass of Li₇La₃Zr₂O₁₂ (hereinafter abbreviated as LLZO) as high dielectric oxide solids 13 was added to 100 parts by mass of artificial graphite (AG) as a negative electrode active material 12, to prepare artificial graphite to which LLZO was added (hereinafter abbreviated as LLZO added AG).
The artificial graphite had a median diameter of 12.0 μm, and LLZO had a median diameter of 0.5 μm.
The powder relative dielectric constant of LLZO was 49.

Next, LLZO added AG, acetylene black (AB) as a electroconductive auxiliary agent, and carboxy methylcellulose (CMC) and styrene butadiene rubber (SBR) as a binder at a mass ratio of LLZO added AG:AB:CMC:SBR=96.5:1:1:1.5 were mixed with distilled water as a dispersing solvent, to prepare a negative electrode paste.

That is, the blending amount of the high dielectric oxide solids 13 in the negative electrode mixture layer 6 was 2.8; by mass.

[Preparation of Lithium Ion Secondary Battery]

Next, a lithium ion secondary battery 1 was prepared in the same manner as in Example 1 except that the negative electrode paste prepared in this Example was used.
The lithium ion secondary battery 1 obtained in this Example includes the high dielectric oxide solids 13 in both a positive electrode 4 and a negative electrode 7. As shown in FIG. 2, a positive electrode active material 11 and the negative electrode active material 12 are in contact with the high dielectric oxide solids 13 on parts of the active material surface, and is in contact with the electrolyte solution 9 on the rest of the surface.

### Comparative Example 1

### [Preparation of Lithium Ion Secondary Battery]

Without using any high dielectric oxide solid 13, NCM622, AB, and PVDF at a mass ratio of 93:4:3 were mixed with N-methyl-N-pyrrolidinone (NMP) as a dispersing solvent, to prepare a positive electrode paste.

Next, a lithium ion secondary battery 1 was prepared in the same manner as in Example 1 except that a negative electrode paste prepared in this Comparative Example was used and 0.107 g of an electrolyte solution 9 corresponding to 100 parts by mass of the mass filling the total volume of the gaps in a positive electrode mixture layer 3, a negative electrode mixture layer 6, and a separator 8 was used.

In the lithium ion secondary battery 1 obtained in this Comparative Example, all of the electrolyte solution 9 was held in the gaps in the positive electrode mixture layer 3, the negative electrode mixture layer 6, and the separator 8, and the electrolyte solution 9 was not stored in the bottom of a container 10.
As a result, in the lithium ion secondary battery 1 obtained in this Comparative Example, an end of the separator 8 was not immersed in the electrolyte solution 9.

### Comparative Example 2

### [Preparation of Positive Electrode]

First, 5.5 parts by mass of LATP as high dielectric oxide solids 13 was added to 100 parts by mass of NCM622 as a positive electrode active material 11, to prepare NCM622 in which the entire surface was coated with LATP (hereinafter, abbreviated as LATP coated NCM622).

Next, LATP coated NCM622, acetylene black (AB) as an electroconductive auxiliary agent, and polyvinylidene fluoride (PVDF) at a mass ratio of LATP coated NCM622:AB:PVDF=93:4:3 were mixed with N-methyl-N-pyrrolidinone (NMP) as a dispersing solvent, to prepare a positive electrode paste.

That is, the blending amount of the high dielectric oxide solids 13 in a positive electrode mixture layer 3 was 4.8% by mass.

[Preparation of Lithium Ion Secondary Battery]

Next, a lithium ion secondary battery 1 was prepared in the same manner as in Example 1, except that the positive electrode paste prepared in this Comparative Example was used.
The lithium ion secondary battery 1 obtained in this Comparative Example included the high dielectric oxide solids 13 only in a positive electrode 4, and the positive electrode active material 11 had its entire surface coated with the high dielectric oxide solids 13, in other words, the positive electrode active material 11 had its entire surface in contact with the high dielectric oxide solids 13. In the lithium ion secondary battery 1 obtained in this Comparative Example, an end of a separator 8 was immersed in an electrolyte solution 9 stored in the bottom.

<Evaluation>

The lithium ion secondary batteries obtained in Examples 1 to 3 and Comparative Examples 1 and 2 were evaluated as follows.

[Initial Discharge Capacity]

The obtained lithium ion secondary battery 1 was left to stand at a measurement temperature of 25° C. for 1 hour, then was subjected to constant current charge at 0.33 C to 4.2 V and subsequently to constant voltage charge at 4.2 V for 1 hour, then was left to stand for 30 minutes. Discharge was permitted at a discharge rate of 0.2 C to 2.5 V, and a discharge capacity was measured.
The results are shown in Table 1.

[Initial Cell Resistance]

The lithium ion secondary battery 1 after the measurement of the initial discharge capacity was adjusted to a state of charge (SOC) of 50%.
Next, the lithium ion secondary battery was subjected to pulse discharge at a C rate of 0.2 C for 10 seconds, and the voltage at the time of the completion of the 10 seconds discharge was measured.
Then, the voltage at the time of the completion of the 10 seconds discharge was plotted with respect to the current at 0.2 C, with the horizontal axis being the current value, and the vertical axis being the voltage.
Next, after being left to stand for 5 minutes, the lithium ion secondary battery was subjected to auxiliary charge to reset the SOC to 50%, and further left to stand for 5 minutes.

Next, the operation described above was carried out at C rates of 0.5 C, 1 C, 2 C, 5 C, and 10 C, and the voltage at the time of the completion of the 10 seconds discharge was plotted with respect to the current for each C rate.

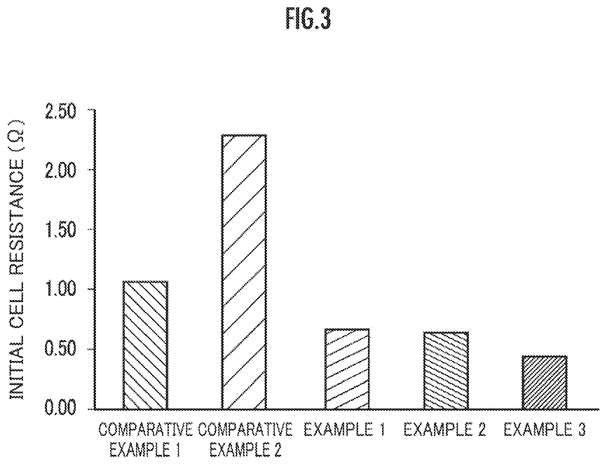

Then, the slope of the approximate straight line obtained from each plot was designated as the initial cell resistance of the lithium ion secondary battery 1.
The results are shown in Table 1 and FIG. 3.

[Discharge Capacity after Durability Test]

As a charge-discharge cycle durability test, one cycle was defined as an operation of constant current charge at 1 C to 4.2 V, and subsequent constant current discharge at a discharge rate of 2 C to 2.5 V in a thermostated bath at 45° C., and this operation was repeated 500 cycles.
After the completion of the 500 cycles, the thermostated bath was set to 25° C., and the lithium ion secondary battery was left to stand for 24 hours as it was after the 2.5 V discharge, and subsequently, the discharge capacity after durability test was measured in a similar manner to the measurement of the initial discharge capacity.
The results are shown in Table 1.

[Cell Resistance after Durability Test]

The lithium ion secondary battery after the measurement of the discharge capacity after durability test was adjusted so as to have a state of charge (SOC) of 50%, and the cell resistance after durability test was determined in accordance with a similar method to the measurement of the initial cell resistance.
The results are shown in Table 1.

[Capacity Maintenance Rate]

The discharge capacity after durability test with respect to the initial discharge capacity was determined, and this was designated as the capacity maintenance rate.
The results are shown in Table 1.

[Rate of Increase of Cell Resistance]

The cell resistance after durability test with respect to the initial cell resistance was determined, and this was designated as a rate of increase of cell resistance.
The results are shown in Table 1.

TABLE 1

| | | | | | Comparative | Comparative |
|---|---|---|---|---|---|---|
| | | Example 1 | Example 2 | Example 3 | Example 1 | Example 2 |
| Blending location of high dielectric | | Positive | Positive | Both | — | Positive |
| oxide solids | | Electrode | Electrode | Electrode | | Electrode |
| Positive | Blending amount of high dielectic | 0.9 | 3.6 | 0.9 | — | 4.8 |
| electrode | oxide solids (mass %) | | | | | |
| | Type of high dielectric oxide solids | LATP | LATP | LATP | — | LATP |
| | Powder relative dielectric constant | 30 | 30 | 30 | — | 30 |
| | of high dielectric oxide solids | | | | | |
| Negative | Blending amount of high dielectric | — | — | 2.8 | — | — |
| electrode | oxide solids (mass %) | | | | | |
| | Type of high dielectric oxide solids | — | — | LLZO | — | — |
| | Powder relative dielectic constant | — | — | 49 | — | — |
| | of high dielectric oxide solids | | | | | |

| | | | | | |
|---|---|---|---|---|---|
| Initial discharge capacity (mAh) | 30.3 | 30.5 | 30.6 | 30.0 | 29.7 |
| Discharge capacity after durability | 26.7 | 27.5 | 27.5 | 24.6 | 22.6 |
| test (mAh) | | | | | |
| Capacity maintenance rate (%) | 88.1 | 90.2 | 90.0 | 82.0 | 76.0 |
| Initial cell resistance (Ω) | 0.70 | 0.67 | 0.46 | 1.08 | 2.28 |
| Cell resistance after durability test (Ω) | 0.96 | 0.91 | 0.63 | 1.55 | 3.16 |
| Rate of increase of cell resistance (%) | 135.9 | 135.9 | 138.7 | 143.0 | 138.7 |

[Conclusion]

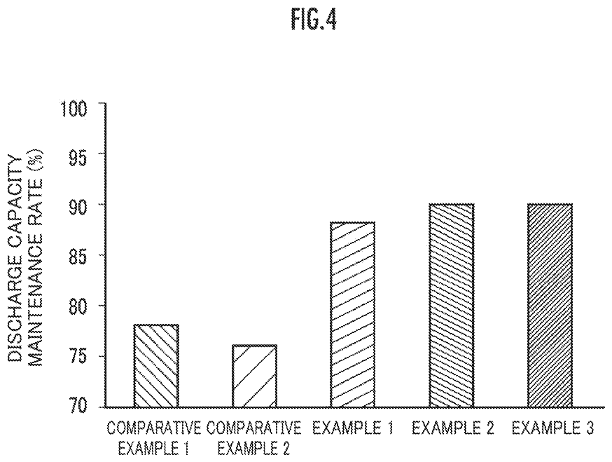

From Table 1 and FIGS. 3 and 4, it is apparent that the lithium ion secondary batteries 1 of Examples 1 to 3, in which at least one of the positive electrode mixture layer 3 or the negative electrode mixture layer 6 includes the high dielectric oxide solids 13, and the positive electrode active material 11 or the negative electrode active material 12 includes sites in contact with the high dielectric oxide solids 13 and sites in contact with the electrolyte solution 9 on the active material surface, have smaller initial cell resistance and larger discharge capacity after durability test and a larger discharge capacity maintenance rate than in the lithium ion secondary battery 1 of Comparative Example 1 or 2 that lacks at least one of such features.

### Example 4

### [Preparation of Positive Electrode]

Acetylene black as an electroconductive auxiliary agent and Li₃PO₄ as high dielectric oxide solids 13 were mixed, and mixed and dispersed using a rotating and revolving mixer, to obtain a mixture. Subsequently, polyvinylidene fluoride (PVD) as a binder, LiNi_{0.5}Co_{0.2}Mn_{0.2}O₂ (NCM622, D50=12 μm) as a positive electrode active material 11, and Li₃PO₄ (powder relative dielectric constant: 48) were added to the obtained mixture, and the mixture was subjected to dispersion treatment using a planetary mixer, to obtain a mixture for a positive electrode mixture.
Note that the components in the mixture for a positive electrode mixture were mixed at a mass ratio of positive electrode active material:LATP:electroconductive auxiliary agent:resin binder (PVDF)=92.1:2:4.1:1.8, that is, the amount of LATP added was 2 parts by mass with respect to 100 parts by mass of the mixture for a positive electrode mixture.
Subsequently, the obtained mixture for a positive electrode mixture was dispersed in N-methyl-2-pyrrolidone (NMP) to prepare a positive electrode mixture paste.

An aluminum foil having a thickness of 12 μm as a positive electrode current collector 2 was provided. The positive electrode mixture paste prepared above was applied to one side of the positive electrode current collector 2, dried at 120° C. for 10 minutes, then was pressed with a roll press at a linear load of 1 t/cm, and subsequently dried in a vacuum at 120° C., to prepare a positive electrode 4 for a lithium ion secondary battery.

Note that the positive electrode 4 prepared thus was punched to a size of 30 mm×40 mm and used.

[Preparation of Negative Electrode]

Sodium carboxy methylcellulose (CM) as a binder and acetylene black as an electroconductive auxiliary agent were mixed and dispersed using a planetary mixer, to obtain a mixture.
Artificial graphite (AG, D50=12 μm) as a negative electrode active material 12 was mixed with the obtained mixture, and the mixture was subjected to dispersion treatment using the planetary mixer again, to obtain a mixture for a negative electrode mixture.
Subsequently, the obtained mixture for a negative electrode mixture was dispersed in N-methyl-2-pyrrolidone (NMP), and styrene butadiene rubber (SBR) as a binder was added, to prepare a negative electrode mixture paste at a mass ratio of negative electrode active material:electroconductive auxiliary agent:styrene butadiene rubber (SBR):binder (CMC)=96.5:1:1.5:1.

A copper foil having a thickness of 12 μm as a negative electrode current collector 5 was provided. The negative electrode mixture paste prepared above was applied to one side of the negative electrode current collector 5, dried at 100° C. for 10 minutes, then was pressed with a roll press at a linear load of 1 t/cm, and subsequently dried in a vacuum at 120° C., to prepare a negative electrode 7 for a lithium ion secondary battery.

Note that the negative electrode 7 prepared thus was punched to a size of 34 mm×44 mm and used.

[Preparation of Lithium Ion Secondary Battery]

A nonwoven fabric having a three-layer laminate structure of polypropylene/polyethylene/polypropylene (thickness: 20 μm) as a separator 6 was provided.
A laminate of the positive electrode 4, the separator 8, and the negative electrode 7 prepared above was inserted into a pouch-like container 10 prepared by heat-sealing an aluminum laminate for secondary batteries (manufactured by Dai Nippon Printing Co., Ltd.).

At this time, in the same manner as in Example 1, the separator 8 was sandwiched between a positive electrode mixture layer 3 of a positive electrode 4 and a negative electrode mixture layer 6 of a negative electrode 7, so that a part where the positive electrode mixture layer 3 of the positive electrode current collector 2 was not formed and a part where the negative electrode mixture layer 6 of the negative electrode current collector 5 was not formed were outside the container 10. After an electrolyte solution 9 was injected into the container 10, the container 10 was vacuum-sealed, to prepare a lithium ion secondary battery 1 in which an end of the separator 8 was immersed in the electrolyte solution 9 stored in the bottom, as shown in FIG. 1.

As the electrolyte solution 9, a solution in which LiPF₆ was dissolved at a concentration of 1.0 mol/L in a solvent in which ethylene carbonate, diethyl carbonate, and ethyl methyl carbonate were mixed at a volume ratio of 30:30:40 was used.

The lithium ion secondary battery 1 of the present Example included the high dielectric oxide solids 13 only in the positive electrode 4, and as shown in FIG. 2, the positive electrode active material 11 was in contact with the high dielectric oxide solids 13 on parts of the active material surface, and was in contact with the electrolyte solution 9 on the rest of the surface.

The obtained lithium ion secondary battery was evaluated in the same manner as in Example 1.
The evaluation results are shown in Table 2.

### Examples 5 to 8

A lithium ion secondary battery was prepared in the same manner as in Example 4 except that the type of high dielectric oxide solids 13 to be blended into a positive electrode mixture layer 3 in a positive electrode 4 was changed as shown in Table 2.
The obtained lithium ion secondary battery was evaluated in the same manner as in Example 1.
The evaluation results are shown in Table 2.

TABLE 2

| | | Example 4 | Example 5 | Example 6 | Example 7 | Example 8 |
|---|---|---|---|---|---|---|
| Blending location of high dielectric | | Positive | Positive | Positive | Positive | Positive |
| oxide solids | | electrode | electrode | electrode | electrode | electrode |
| Positive | Blending amount of high dielectric | 2.0 | 2.0 | 2.0 | 2.0 | 2.0 |
| electrode | oxide solids (mass %) | | | | | |
| | Type of high dielectric oxide solids | Li₃PO₄ | LiNbO₂ | BaTiO₃ | KNbO₃ | SrBi₂Ta₂O₉ |
| | Powder relative dielectric constant | 48 | 201 | 67 | 698 | 20 |
| | of high dielectric oxide solids | | | | | |
| Negative | Blending amount of high dielectric | — | — | — | — | — |
| electrode | oxide solids (mass %) | | | | | |
| | Type of high dielectric oxide solids | — | — | — | — | — |
| | Powder realtive dielectric oxide solids | | | | | |

| | | | | | |
|---|---|---|---|---|---|
| Initial discharge capacity (mAh) | 29.7 | 29.7 | 29.7 | 29.7 | 29.7 |
| Discharge capacity after durability test (mAh) | 25.2 | 26.1 | 25.2 | 25.8 | 25.8 |
| Capacity maintenance rate (%) | 85.0 | 88.0 | 85.0 | 87.0 | 87.0 |
| Initial cell resistance (Ω) | 0.87 | 0.83 | 0.87 | 0.69 | 0.69 |
| Cell resistance after durability test (Ω) | 1.18 | 1.10 | 1.18 | 0.89 | 0.96 |
| Rate of increase of cell resistance (%) | 135.9 | 131.9 | 135.9 | 128.4 | 138.5 |

### Example 9

### [Preparation of Positive Electrode]

A positive electrode 4 for a lithium ion secondary battery was prepared in the same manner as in Example 4 except that high dielectric oxide solids 13 were not added in the positive electrode 4.

[Preparation of Negative Electrode]

Artificial graphite (AG, D50=12 μm) as a negative electrode active material 12, Li₅La₃Ta₂O₁₂ (powder relative dielectric constant: 48) as high dielectric oxide solids 13, and acetylene black as an electroconductive auxiliary agent were mixed, and mixed and dispersed using a rotating and revolving mixer, to obtain a mixture.
Subsequently, the obtained mixture was dispersed in distilled water, and carboxy methylcellulose (CMC) and styrene butadiene rubber (SBR) were added as a binder, and the mixture was subjected to dispersion treatment using a planetary mixer, to obtain a negative electrode mixture paste.
Note that the components in the negative electrode mixture were mixed at a mass ratio of negative electrode active material:high dielectric oxide solids:electroconductive auxiliary agent:SBR:CMC=94.5:2:1:1.5:1, that is, the amount of the high dielectric oxide solids 13 added was 2 parts by mass with respect to 100 parts by mass of the mixture for a negative electrode mixture.

Using the obtained negative electrode mixture paste, a negative electrode for a lithium ion secondary battery was prepared in the same manner as in Example 4, and was punched to a size of 34 mm×44 mm.

[Preparation of Lithium Ion Secondary Battery]

A lithium ion secondary battery was prepared in the same manner as in Example 4 except that an electrolyte solution, in which LiPF₆ was dissolved at 1.2 mol/L, was used.
The obtained lithium ion secondary battery was evaluated in the same manner as in Example 1.
The evaluation results are shown in Table 3.

### Examples 10 to 11

A lithium ion secondary battery was prepared in the same manner as in Example 9 except that the type of high dielectric oxide solids 13 to be blended into a negative electrode mixture layer 6 in a negative electrode 7 was changed as shown in Table 3.
The obtained lithium ion secondary battery was evaluated in the same manner as in Example 1.
The evaluation results are shown in Table 3.

| | | Example 9 | Example 10 | Example 11 |
|---|---|---|---|---|
| Blending location of high dielectric oxide solids | | Negative | Negative | Negative |
| | | electrode | electrode | electrode |
| Positive | Blending amount of high dielectric | — | — | — |
| electrode | oxide solilds (mass %) | | | |
| | Type of high dielectric oxide solids | — | — | — |
| | Powder relative dielectric constant of | — | — | — |
| | high dielectric oxide solids | | | |
| Negative | Blending amount of high dielectric | 2.0 | 2.0 | 2.0 |
| electrode | oxide solilds (mass %) | | | |
| | Type of high dielectric oxide solids | Li₅La₃Ta₂O₁ | Li₃BO₃ | BaTiO₃ |
| | Powder relative dielectric constant of | 48 | 12 | 67 |
| | high dielectric oxide solids | | | |

| | | | |
|---|---|---|---|
| Initial discharge capacity (mAh) | 29.7 | 29.7 | 29.7 |
| Discharge capacty after durability test (mAh) | 26.1 | 25.8 | 26.4 |
| Capacity maintenance rate (%) | 87.9 | 87.0 | 89.0 |
| Initial cell resistance (Ω) | 0.67 | 0.69 | 0.69 |
| Cell resistance after durability test (Ω) | 0.89 | 0.96 | 0.93 |
| Rate of increase of cell resistance (%) | 133.4 | 138.7 | 134.1 |

### EXPLANATION OF REFERENCE NUMERALS

1 lithium ion secondary battery
2 positive electrode current collector
3 positive electrode mixture layer
4 positive electrode
5 negative electrode current collector
6 negative electrode mixture layer
7 negative electrode
8 separator
9 electrolyte solution
10 container
11 positive electrode active material
12 negative electrode active material
13 high dielectric oxide solid

1. A negative electrode for a lithium ion secondary battery comprising an electrode mixture layer containing an electrode active material and high dielectric oxide solids, the electrode active material comprising sites in contact with the high dielectric oxide solids and sites in contact with an electrolyte solution on an active material surface thereof.

2. The electrode for a lithium ion secondary battery according to claim 1, wherein the high dielectric oxide solids are disposed in a gap between the electrode active materials.

3. The electrode for a lithium ion secondary battery according to claim 1, wherein the high dielectric oxide solids are an oxide solid electrolyte.

4. (canceled)

5. (canceled)

6. (canceled)

7. (canceled)

8. (canceled)

9. The negative electrode for a lithium ion secondary battery according to claim 1, wherein the high dielectric oxide solids are a reduction decomposition resistant lithium ion conductive solid electrolyte.

10. The electrode for a lithium ion secondary battery according to claim 9, wherein the reduction decomposition resistant lithium ion conductive solid electrolyte has a reduction decomposition potential of 1.5 V (1.5 V vs Li/Li⁺) or less versus Li/Li⁺ equilibrium potential.

11. The electrode for a lithium ion secondary battery according to claim 10, wherein the reduction decomposition resistant lithium ion conductive solid electrolyte is at least one of Li₇La₃Zr₂O₁₂ or Li_{2.88}PO_{3.73}N_{0.14}.

12. (canceled)

13. A lithium ion secondary battery comprising a positive electrode, a negative electrode, a separator that electrically insulates the positive electrode and the negative electrode, and an electrolyte solution, the negative electrode being the negative electrode for a lithium ion secondary battery according to claim 1.

14. (canceled)

15. The lithium ion secondary battery according to claim 13 comprising a container that houses the positive electrode, the negative electrode, the separator, and the electrolyte solution, the separator being in contact with the electrolyte solution stored in the container.

16. The electrode for a lithium ion secondary battery according to claim 2, wherein the high dielectric oxide solids are an oxide solid electrolyte.

17. The negative electrode fora lithium ion secondary battery according to claim 2, wherein the high dielectric oxide solids are a reduction decomposition resistant lithium ion conductive solid electrolyte.

18. The negative electrode for a lithium ion secondary battery according to claim 3, wherein the high dielectric oxide solids are a reduction decomposition resistant lithium ion conductive solid electrolyte.
